(19) United States
(12) Patent Application Publication
(10) Pub. No.: US 2009/0026175 A1
(43) Pub. Date: Jan. 29, 2009

(54) ION FUSION FORMATION PROCESS FOR LARGE SCALE THREE-DIMENSIONAL FABRICATION

(75) Inventor: Robbie J. Adams, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/828,819

(22) Filed: Jul. 26, 2007

(51) Int. Cl. B23K 10/00; B05D 1/08; B23K 9/04

(52) U.S. Cl. 219/76.16; 219/76.1; 427/446

(57) ABSTRACT

An ion fusion formation (IFF) system and method is used to fabricate a large scale three-dimensional structure in a continuous manner from successive layers of feedstock material. The system includes a moveable positioning arm coupled to a control platform. The positioning arm includes a deposition head, including a high energy beam and a feedstock feed mechanism mounted thereto. The deposition head is positioned relative to a targeted region by positioning and repositioning the moveable positioning arm, thereby providing a means for fabricating a large scale three-dimensional structure in a continuous manner. A plurality of control components coupled to the control platform are programmable to control the positioning arm whereby a plurality of customizable control parameters are input into the control components and provide positioning and repositioning of the positioning arm to align the deposition head relative to the predetermined targeted region.

### TECHNICAL FIELD

The present invention relates to the fabrication of large scale three-dimensional structures, and more particularly relates to solid free-form fabrication processes to create large scale three-dimensional structures.

### BACKGROUND

Manufacturers of large equipment components and structures such as ships, bridges, buildings and other large structures face a complex challenge due to the many manufacturing steps involved in their fabrication. Typically, a plurality of pre-processed components that comprise these large structures are manufactured at plants with specialized manufacturing equipment and assembled at a fabrication site such as a shipyard, typically through welding. Alternatively, the structures may be assembled in very large specialized building facilities; such as floating dry-docks in the case of ships. In either case, the multiple steps involved in manufacturing and transporting the components to a fabrication site is costly and time consuming. This is also true for moderate sized structures not quite as large as ships, bridges, or the like.

One technique gaining acceptance to fabricate three-dimensional components and structures is solid free-form fabrication (SFF). SFF is a designation for a group of processes that produce three-dimensional shapes from additive formation steps that could be used in the fabrication of three-dimensional components. SFF does not implement any part-specific tooling except a starter slab. Instead, a three dimensional component is often produced from a graphical representation devised using computer-aided modeling (CAM). This computer representation may be, for example, a layer-by-layer slicing of the component shape into consecutive two dimensional layers, which can then be fed to control equipment to fabricate the part. Alternatively, the manufacturing process may be user controlled instead of computer controlled. Generally speaking, a component may be manufactured using SFF by successively building feedstock layers representing successive cross-sectional component slices. Although there are numerous SFF systems that use different components and feedstock materials to build a component, SFF systems can be broadly described as having a stationary automated platform/positioner for receiving and supporting the feedstock layers during the manufacturing process, a feedstock supplying apparatus that directs the feedstock material to a predetermined region to build the feedstock layers, and an energy source directed toward the predetermined region. The energy from the energy source modifies the feedstock in a layer-by-layer fashion in the predetermined region to thereby manufacture the component as the successive layers are built onto each other.

One recent implementation of SFF is generally referred to as ion fusion formation (IFF). With IFF, a heat source from a plasma discharge, whose components can be customized, or an off-the-shelf device such as a plasma, gas tungsten arc, plasma arc welding, or other torch with a variable orifice is incorporated in conjunction with a stock feeding mechanism to direct molten feedstock to a targeted surface such as a base substrate or an in-process structure of previously-deposited feedstock. A component is built using IFF by applying small amounts of molten material only where needed in a plurality of deposition steps, resulting in net-shape or near-net-shape parts without the use of machining, molds, or mandrels. The deposition steps are typically performed in a layer-by-layer fashion on a stationary platform or positioner wherein slices are taken through a three dimensional electronic model by a computer program.

One inherent challenge that is present when using SFF, and more particularly an IFF process, to build a large scale component is with the positioning system. The positioning system generally serves to position a workpiece, so that operations can be performed on it by adding additional material through a wire or powder feed mechanism, referred to herein as a feedstock feed mechanism, at a deposition point. The positioning system may coordinatingly control all three participants of the workpiece manufacturing process, namely the workpiece; the feedstock feed mechanism, and the plasma welding torch. In this way, three-dimensional articles can be fabricated in a predictable, highly-selectable, and useful manner. Control of the positioning system may be achieved manually, by computer-implemented control software, or the like.

Another challenge inherent to building very large structures is the need to overcome the very large heat sink action created by the large mass of metal in a large structure. The small components built to date experience a temperature rise as layers are added to build the component. Thus not only is the feedstock melted but the substrate is also melted and optimum fusion between the two is formed. However, a large structure may be too large to have its temperature raised significantly. Hence a danger exists that the substrate may not fully melt the feedstock and it will not fully fuse to the substrate. Thus an unsafe partially consolidated structure could be built without adequate heat input and heat input control.

Another challenge is faced by one type of SFF system in which a bed of powder is selectively consolidated layer by layer until a component is fully built. This would be very difficult approach to build a large structure.

When using an SFF process to fabricate the above-mentioned large structures and components, the location of the component to be prepared presents a challenge. In many instances a platform or positioning system would become too large to bring it to the component to be built, such as with the fabrication of ships, bridges, or the like.

Hence, there is a need for an IFF process that enables the fabrication of these large components by enabling the entire structure to be created at a single location via continuous fabrication of the structure, therefore minimizing additional transportation and assembly steps, reducing manufacturing costs, and reducing manufacturing time.

### BRIEF SUMMARY

There has now been developed a solid free form fabrication (SFF) system for fabricating large scale three-dimensional structures in a continuous manner with successive layers of a feedstock material. In one particular embodiment, and by way of example only, the system comprises a deposition head, a localized shielding apparatus, a positioning arm, and a control platform. The deposition head is operable to emit an energy beam in a path and to feed the feedstock material into the path of the energy beam, the feedstock material melting at a deposition point when introduced into the path and defining a fused area and a hot area extending beyond the fused area. The localized shielding apparatus is configured to protect the fused area and the hot area from oxidation. The positioning arm is coupled to the deposition head and the control platform is coupled to the positioning arm. The control platform includes a plurality of control components for controlling a position of the positioning arm and operation of the deposition head. The positioning arm is moveable to align the deposition head with a targeted region of the large scale three-dimensional structure to manufacture the large scale three-dimensional structure by transferring the feedstock material in a controlled manner by melting the feedstock material at the deposition point and allowing it to re-solidify at the targeted region.

In yet another embodiment, by way of example only, there is provided a solid free form fabrication (SFF) system for fabricating large scale three-dimensional structures in a continuous manner with successive layers of a feedstock material comprising: a deposition head operable to emit an energy beam in a path and to feed the feedstock material into the path of the energy beam. The feedstock material melting at a deposition point when introduced into the path and defining a fused area and a hot area extending beyond the fused area. The system further comprising a localized shielding apparatus configured to protect the fused area and the hot area from oxidation. A positioning arm is coupled to the deposition head and a control platform is coupled to the positioning arm. The control platform includes a plurality of control components for controlling a position of the positioning arm and operation of the deposition head. The positioning arm is moveable to align the deposition head with a targeted region of the large scale three-dimensional structure to manufacture the large scale three-dimensional structure by transferring the feedstock material in a controlled manner by melting the feedstock material at the deposition point and allowing it to re-solidify at the targeted region.

In a further embodiment, still by way of example only, there is provided a large scale three-dimensional ion fusion formation method for fabricating large scale three-dimensional structures in a continuous manner with successive layers of a feedstock material. The method comprising the step of providing a positioning arm including a deposition head mounted thereto. The deposition head creating a plasma stream in a plasma path. The method further comprising the steps of feeding the feedstock material into the plasma path and providing a plurality of control components coupled to a control platform, whereby the positioning arm is coupled to the control platform. The plurality of control components are programmable to control the positioning arm whereby a plurality of customizable control parameters are input into the plurality of control components. The plurality of customizable control parameters are configured to maintain current amperage and travel speed such that an energy level of the plasma stream is optimized to fuse the feedstock material at a predetermined targeted region. The method further comprising the steps of shielding the deposition head and the predetermined targeted region and positioning the positioning arm to align the deposition head relative to the predetermined targeted region to fabricate the large scale three-dimensional structure in the predetermined targeted region.

Other independent features and advantages of the preferred apparatus and method will become apparent from the following detailed description, taken in conjunction with the accompanying drawings which illustrate, by way of example, the principles of the invention.

### BRIEF DESCRIPTION OF THE DRAWINGS

FIG. 1 is a perspective view of an IFF system for large scale three-dimensional structure fabrication; and

FIG. 2 is closer view of the targeted region for the fabrication of the large scale three-dimensional structure.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, before proceeding with the detailed description, it is to be appreciated that the described embodiment is not limited to use in conjunction with a specific type of structure. Thus, although the description is explicitly directed toward an embodiment that is used to fabricate a substantially vertical large scale continuous three-dimensional structure, it should be appreciated that it can be used to fabricate many types of large scale three-dimensional structures, such as ships, bridges, or the like in a continuous fabrication method including those known now or hereafter in the art.

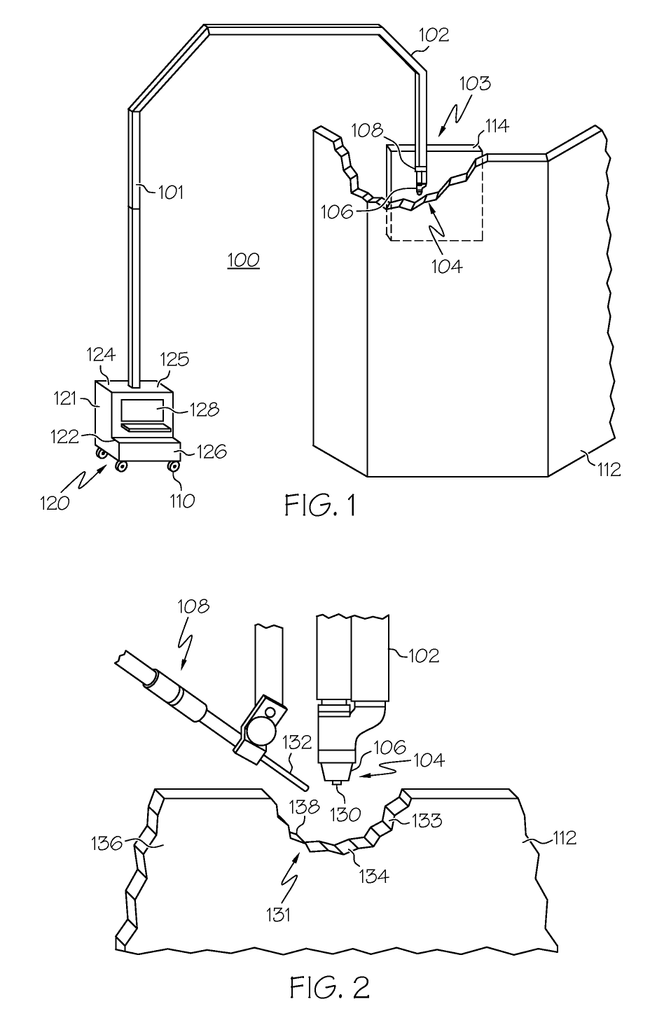

FIG. 1 is a perspective view an IFF system 100 for large scale three-dimensional fabrication, which includes a positioning arm 102, having formed at a distal end 103, a deposition head 104. The deposition head 104 has formed as a part thereof a heating energy beam 106 that functions in cooperation with a feedstock feed mechanism 108 positioned in close proximity, to build up the structure being fabricated in a continuous or layer-by-layer manner. Examples of heating energy beam 106 may include, but are not limited to electromagnetic beams, including laser beams or the like, particle beams, such as electron beams or ion beams, and plasma beams, such as gas tungsten arc, plasma arc, or the like. The positioning arm 102 aids in continuously positioning and repositioning the IFF system 100 relative to the structure in a manner whereby feedstock material may be added to it through the feedstock feed mechanism 108 at predetermined deposition points. More specifically, the IFF system 100 is moveably disposed relative to the structure being fabricated and includes a moving means 110 for moving the IFF system 100 relative to the structure being fabricated. The positioning arm 102 may also be configured to coordinate movement and control of the heating energy beam 106 and the feedstock feed mechanism 108 together with the workpiece to fabricate three-dimensional articles in a predictable, highly selectable, and useful manner. In many instances the positioning arm 102 may include any number of extendable components 101 when necessary to further aid the IFF system 100 in reaching the desired the deposition points. Control of the positioning arm 102 may be achieved by computer-implemented control software or the like. The coordinated heating energy beam 106, the feedstock feed mechanism 108, and the positioning arm 102 provide a highly flexible, manually adaptable, and spontaneously contractible automated system through which a large scale three-dimensional structure 112 may be fabricated in a continuous manner to net or near-net shape.

As illustrated in FIG. 1, the IFF system 100 is positioned relative to the large scale three-dimensional structure 112 desired to be built. The large scale three-dimensional structure 112 is fabricated using the IFF system 100 in a continuous layer-by-layer method so as to eliminate any need for an external support structure, or require only limited support during fabrication. As the large scale three-dimensional structure 112 is built it is designed to support itself. In many instances, as the structure being built increases in size or height, the IFF system 100 is intended to similarly move in height with the built structure in a manner generally similar to a climbing tower crane utilized in the construction field that is configured to move or increase in height with the increasing height of the structure it is helping to build.

In contrast to previous IFF systems used for fabricating small scale structures, localized shielding is utilized in the IFF system 100. More specifically, a shield or shielding structure 114 is formed about the area being worked on at any given time to protect the remaining built structure from the hot portion. There is no need to protect the entire structure.

Additional elements depicted in FIG. 1 include a control platform 120, including a plurality of control components 121, such as a gas controller 122 that controls gas and/or fluid flow to the heating energy beam 106, which is preferably a plasma welding torch. The plurality of control components 121 are configured to control operation of the deposition head 104 to vary an energy level of the emitted heating energy beam 106, thereby optimizing a heat input level.

An energy beam, such as a plasma or arc power source, referred to herein as a power source 124, supplies the necessary power to the heating energy beam 106. The moveable means for moving the positioning arm 102 relative to the large scale three-dimensional structure 112 being fabricated may include positioners and/or positioning motors 125 that are supplied with positioning signals from an electric drive 126 that is coupled to a computer 128 or other controlling device. The positioning arm 102 may be provided of a sufficient length to allow for positioning of the deposition head 104 separate and apart from the control components 121 and in closer proximity to the large scale three-dimensional structure 112 to be built. It should be understood that while gas controller 122, power source 124, electric drive 126 and computer 128 are illustrated as components being housed within a single housing, in an alternate embodiment they may be formed as separate components being housed within separate housings dependent upon space requirements.

In contrast to prior IFF systems that were only capable of building small scale structures, in this particular embodiment the deposition head 104 is positionable relative to a large scale three-dimensional structure being fabricated in a continuous manner by the repositioning of the IFF system 100, and more particularly the positioning arm 102. The deposition head 104 is coupled to the positioning arm 102 that acts in a similar manner to a robotic arm. The deposition head 104 is typically fixably mounted to positioning arm 102, but may be removeably mounted when required. The positioners and/or positioning motors 125 when supplied with positioning signals provide control and movement of positioning arm 102. More specifically, during operation a plurality of customizable control parameters are input to the control components 121 to provide positioning and repositioning of the positioning arm 102. The positioning arm 102 provides positioning of the deposition head 104, including the heating energy beam 106 and the feedstock feed mechanism 108, in multiple dimensions as needed, for instance along an X, Y, and/or Z axis, including deposition head rotation and tilt, relative to the large scale three-dimensional structure being built.

A closer view of the operating area for the building of the large scale three-dimensional structure 112 is further detailed in FIG. 2. The deposition head 104 includes the heating energy beam 106 in cooperation with the feedstock feed mechanism 108. During operation, an arc electrode (not shown) is positioned inside a nozzle 130 and inside a gas flow channel of heating energy beam 106, and operates to ionize a gas and create a hot argon plasma before the gas exits the nozzle 130. Upon being energized, the argon gas rapidly accelerates from the nozzle 130 toward a targeted region 131 of the large scale three-dimensional structure 112. The feedstock feed mechanism 108 introduces a feedstock material 132 between the heating energy beam 106 and the targeted region 131 of the large scale three-dimensional structure 112 being fabricated. More specifically, the deposition head 104 is operable to emit the heating energy beam 106 in a path by energizing the flowing gas and to feed the feedstock material 132 into the path of the heating energy beam 106. The feedstock material 132 is thereby caused to melt at a deposition point 133 when introduced into the path and define a fused area 134 and a hot area 136 extending beyond the fused area 134. In a preferred embodiment, the heating energy beam 106 is configured to metallurgically bond the feedstock material 132 to a substrate 138 at the targeted region 131 and counteract a heat sink effect of the large scale three-dimensional structure 112. In one particular embodiment, the deposition head 104 includes a plasma torch positioned to emit a plasma stream in a plasma path.

If the heating energy beam 106 is electrical in nature the energy beam can be transferred or non-transferred to the substrate. In an exemplary embodiment, the shield 114 (FIG. 1) enables the creation of an electrical circuit including the ionized gas about the targeted region 131 to aid in the acceleration and attraction of the ions from the nozzle 130. The targeted region 131 may be charged by applying a voltage that is opposite of the charge generally present in the ionized plasma gas. The ionized gas is then electrically attracted to the targeted region 131. Use of such electrical charge at the targeted region 131 may also serve to control the direction and distribution of the ionized plasma gas. The degree of attraction between the ions and the targeted region 131 may be controlled by increasing or decreasing the charge present at the targeted region 131.

A noble gas such as argon is preferably ionized using the arc electrode (not shown) positioned near the nozzle 130 of the heating energy beam 106, although alternative inert gases, ions, molecules, or atoms, including, but not limited to, H₂0, CO₂ and O₂, may be used in conjunction with the heating energy beam 106 instead of argon or in combination with argon. These alternative mediators of the plasma energy may include positive and/or negative ions or electrons alone or together with ions. Further, reactive elements may be combined with an inert gas such as argon to optimize performance of the heating energy beam 106. The plasma generating process so energizes the argon gas that the gas temperature is raised to between 5,000 and 30,000 K. Consequently, only a small volume of energized argon gas is required to melt feedstock material 132 from the feedstock feed mechanism 108. Nozzles of varying apertures or other orifices may be used to provide specific geometry and plasma collimation for the fabrication of different type structures. Direct beam nozzle orifices may contrast with nozzles having a fan shape or other shapes.

The ionized argon plasma, and all other ionized noble gases, have strong affinity for electrons and will obtain them from the surrounding atmosphere unless the atmosphere consists of gases having equal or higher electron affinity. One advantage of the exemplary large scale three-dimensional IFF system depicted in the drawings does not require a pressurization chamber or other chamber in which the ambient gas is controlled and allows for mobility of the positioning arm 102 and deposition head 104. However, to prevent the ionized argon plasma from obtaining electrons and/or ions from the surrounding atmosphere, i.e. from nitrogen and oxygen typically present in ambient environments, the ionized argon plasma may additionally be sheathed or protected by a curtain of helium, another noble gas, or other inert gases flowing from the nozzle 130 from a coaxial channel (not shown). The shield 114 is positioned to aid in the sheathing or protection. Helium and other noble gases hold their electrons with a high degree of affinity, and are less susceptible than oxygen or nitrogen to having its electrons taken by the ionized argon plasma.

Any material susceptible to melting by an energy beam, argon ion or other plasma beam may be supplied using a powder feed mechanism or the feedstock feed mechanism 108 as feedstock material 132. Such materials may include steel alloys, aluminum alloys, titanium alloys, nickel alloys, although numerous other materials may be used as feedstock depending on the desired material characteristics such as fatigue initiation, crack propagation, post-fabrication toughness and strength, and corrosion resistance at both welding temperatures and those temperatures at which the structure will be exposed. Specific operating parameters including plasma temperatures, build materials, melt pool parameters, nozzle angles and tip configurations, inert shielding gases, dopants, and nozzle coolants may be tailored to fit an IFF process. U.S. Pat. No. 6,680,456 discloses an IFF system and various operating parameters, and is hereby incorporated herein by reference.

As previously discussed, one inherent challenge when fabricating large scale three-dimensional structures is fabrication of a continuous structure without the need for additional structural support or assembly steps. Use of the IFF system 100 provides for close proximity between the deposition head 104 and the targeted region 131 of the large scale three-dimensional structure 112. As illustrated in FIG. 1, the IFF system 100 provides separation between the portion of IFF system 100 that controls the fabrication process, namely the gas controller 122, the power source 124, the electric drive 126 and the computer 128 and the portion of the IFF system 100 that supplies the actual deposition of the feedstock material 132 to the targeted region 131 of the large scale three-dimensional structure 112 being built. More specifically, the IFF system 100 allows for the positioning and repositioning of the positioning arm 102, and more particularly, the deposition head 104 near or proximate the targeted region 131 while the control platform 120, and more particularly, the control components 121 are positioned separate and apart. In a preferred embodiment, the control components 121 may be repositioned relative to the large scale three-dimensional structure 112 being built to enable the system to reach the targeted region 131. A control link (not shown) provides control of the positioning arm 102 and the deposition head 104 via the positioners and/or positioning motors 125. To this effect, software programs may be implemented by for the computer 128 to control the deposition rate, heat input and movement of the positioning arm 102, and thus the deposition head 104. In that the IFF system 100 is readily reconfigurable, it can be customized for different applications.

Thus, the IFF system 100 of the present invention includes various mechanisms for improving accessibility between the deposition head 104 and a targeted region 131 of the large scale three-dimensional structure 112 being fabricated. The configuration of the IFF system 100 to include the moveable positioning arm 102, the control platform 120, and the mounting of the deposition head 104 on a repositionable positioning arm 102 provides customization of the IFF system 100 and allows for the IFF system 100 to be brought to, and if necessary increase in build height, with the large scale three-dimensional structure 112 being fabricated. The positioning arm 102 is positionable to align the deposition head 104 with the targeted region 131 to fabricate the large scale three-dimensional structure 112 by transferring the feedstock material 132 from the feedstock feed mechanism 108 in a controlled manner by melting the feedstock material 132 at a deposition point and allowing it to re-solidify at the targeted region 131 or on previously-deposited feedstock material.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A solid free form fabrication (SFF) system for fabricating large scale three-dimensional structures in a continuous manner with successive layers of a feedstock material comprising:
a deposition head operable to emit an energy beam in a path and to feed the feedstock material into the path of the energy beam, the feedstock material melting at a deposition point when introduced into the path and defining a fused area and a hot area extending beyond the fused area;
a localized shielding apparatus configured to protect the fused area and the hot area from oxidation;
a positioning arm coupled to the deposition head; and
a control platform coupled to the positioning arm, the control platform including a plurality of control components for controlling a position of the positioning arm and operation of the deposition head,
whereby the positioning arm is moveable to align the deposition head with a targeted region of the large scale three-dimensional structure to manufacture the large scale three-dimensional structure by transferring the feedstock material in a controlled manner by melting the feedstock material at the deposition point and allowing it to re-solidify at the targeted region.

2. The system of claim 1, wherein the energy beam is configured to metallurgically bond the feedstock material to a substrate at the targeted region and counteract a heat sink effect of the large scale three-dimensional structure.

3. The system of claim 1, wherein the plurality of control components are configured to control operation of the deposition head to vary an energy level of the energy beam, thereby optimizing a heat input level.

4. The system of claim 1, wherein the deposition head is fixably mounted to the positioning arm.

5. The system of claim 1, wherein the deposition head includes a plasma torch positioned to emit the plasma stream in a plasma path and a feedstock feed mechanism operable to feed the feedstock material into the plasma path of the plasma torch.

6. The system of claim 1, wherein a plurality of customizable control parameters are input into the plurality of control components to provide positioning and repositioning of the positioning arm.

7. The system of claim 6, wherein the plurality of control components include a gas controller, a power source, an electric drive and a computer.

8. The system of claim 6, wherein the plurality of control components are housed within a single housing.

9. The system of claim 6, wherein the plurality of control components are housed separately within a plurality of housings.

10. The system of claim 6, wherein the plurality of customizable control parameters are input into the plurality of control components for manual control of the positioning arm.

11. The system of claim 6, wherein the plurality of customizable control parameters are input into the plurality of control components for automated control of the positioning arm.

12. An ion fusion formation (IFF) system for fabricating large scale three-dimensional structures in a continuous manner with successive layers of a feedstock material comprising:
a plasma discharge positioned to emit a plasma stream in a plasma path;
a feedstock feed mechanism operable to feed the feedstock material into the plasma path of the plasma discharge;
a positioning arm coupled to the plasma discharge and the feedstock feed mechanism to form a deposition head, whereby the positioning arm is positionable to align the deposition head with a targeted region to fabricate a large scale three-dimensional structure by transferring the feedstock material from the feedstock feed mechanism to the targeted region in a controlled manner by melting the feedstock material at a deposition point and allowing it to re-solidify at the targeted region;
a control platform coupled to the positioning arm, the control platform including a plurality of control components, whereby a plurality of customizable control parameters are input into the plurality of control components and provide positioning and repositioning of the positioning arm and operation of the deposition head; and
a shielding structure positioned to encompass the deposition head and the targeted region.

13. The system of claim 12, wherein the deposition head is fixably mounted to the positioning arm.

14. The system of claim 12, wherein the plurality of control components include a gas controller, a power source, an electric drive and a computer.

15. The system of claim 12, wherein the plurality of customizable control parameters are input into the plurality of control components and provide one of manual control or automated control of the positioning arm.

16. An ion fusion formation method for fabricating large scale three-dimensional structures in a continuous manner with successive layers of a feedstock material, the method comprising the steps of:
providing a positioning arm including a deposition head mounted thereto, the deposition head creating a plasma stream in a plasma path;
feeding the feedstock material into the plasma path;
providing a plurality of control components coupled to a control platform, whereby the positioning arm is coupled to the control platform, the plurality of control components are programmable to control the positioning arm whereby a plurality of customizable control parameters are input into the plurality of control components, the plurality of customizable control parameters configured to maintain current amperage and travel speed such that an energy level of the plasma stream is optimized to fuse the feedstock material at a predetermined targeted region;
shielding the deposition head and the predetermined targeted region; and
positioning the positioning arm to align the deposition head relative to the predetermined targeted region to fabricate the large scale three-dimensional structure in the predetermined targeted region.

17. The method of claim 16, wherein the deposition head includes a plasma discharge positioned to emit the plasma stream in a plasma path and a feedstock feed mechanism operable to feed the feedstock material into the plasma path.

18. The method of claim 16, further including the step of adjusting a rate at which the feedstock material is introduced into the plasma stream to produce an optimal feedstock deposition rate

19. The method of claim 16, wherein the plurality of control components include a gas controller, a power source, an electric drive and a computer.

20. The method of claim 16, wherein the plurality of customizable control parameters are input into the plurality of control components to provide one of manual control or automated control of the positioning arm.
